(19) United States
(12) Patent Application Publication
(10) Pub. No.: US 2007/0144116 A1
(43) Pub. Date: Jun. 28, 2007

(54) Cyclonic cleaner

(75) Inventors: Seung Gee Hong, Suwon-Si (KR); Jun Hwa Lee, Anyang-Si (KR); Hwa Gyu Song, Gwangsan-Gu (KR); Tae Seok Yoon, Ahnyang-Si (KR); Jae Man Joo, Suwon-Si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/483,589

(22) Filed: Jul. 11, 2006

(30) Foreign Application Priority Data
Dec. 23, 2005 (KR) 10-2005-0129012
Dec. 23, 2005 (KR) 10-2005-0129014

(51) Int. Cl. B01D 45/12

(52) U.S. Cl. 55/345

(57) ABSTRACT

A cyclonic cleaner which includes a cyclone unit enabling a reduction of noise generated from the cyclone unit, and reduction in pressure loss by forming a smooth air flow. The cyclone unit includes a body having an air inlet and an air outlet, a primary cyclone to primarily separate foreign matter from air drawn through the air inlet, a plurality of secondary cyclones to secondarily separate foreign matter from air discharged from the primary cyclone and to discharge the air having the foreign matter removed therefrom through discharge holes of the secondary cyclones, and a noise reduction member positioned in the discharge hole of each secondary cyclone to reduce noise. The cyclone unit also includes a guide plate to allow the air discharged through the discharge holes of the secondary cyclones to be smoothly discharged through the air outlet.

### CROSS-REFERENCE TO RELATED APPLICATIONS

This application claims the benefit of Korean Patent Application Nos. 10-2005-0129012 and 10-2005-0129014, both filed on Dec. 23, 2005, in the Korean Intellectual Property Office, the disclosures of which are incorporated herein by reference.

### BACKGROUND OF THE INVENTION

1. Field of the Invention

The present invention relates to a cyclonic cleaner More particularly, to a cyclonic cleaner which includes a cyclone unit to centrifugally separate foreign matter from air drawn into the cleaner.

2. Description of the Related Art

Generally, a conventional cyclonic cleaner includes a blower fan unit, which includes a blower fan and a motor to generate suction force, and a cyclone unit to filter foreign matter from air suctioned into a body of the cyclonic cleaner, by the suction force generated from the blower fan unit.

The cyclone unit includes a primary cyclone to primarily separate the foreign matter from air by generating circulating air flow, and a plurality of secondary cyclones to secondarily separate foreign matter from the air after separately receiving the air discharged from the primary cyclone. After being discharged from the secondary cyclones, the air is discharged through a discharge hole of each secondary cyclone. However, the discharge hole of the secondary cyclone has a smaller diameter than that of a discharge hole of the primary cyclone, so that severe noise is generated from the discharge holes of the secondary cyclones when the air passes through the discharge holes of the secondary cyclones while rapidly circulating within the discharge holes.

Furthermore, in the conventional cyclone unit, since air is discharged through an air vent formed at one side of the cyclone unit without any guidance of air flow after being discharged through the discharge holes of the secondary cyclones facing upward, the air discharged through the discharge holes of the secondary cyclones collides with an upper cover of the cyclone unit, and generates noise. In addition, due to collision of the air discharged through the discharge holes of the secondary cyclones with the upper cover, air flow becomes turbulent, causing pressure loss.

### SUMMARY OF THE INVENTION

Accordingly, it is an aspect of the present invention to provide a cyclonic cleaner which enables reduction of noise generated from discharge holes of secondary cyclones without reducing efficiency of separating foreign matter.

It is another aspect of the present invention to provide the cyclonic cleaner which enables natural guidance of air discharged from the discharge holes of the secondary cyclones, preventing generation of noise, and forms smooth air flow, thereby reducing pressure loss.

Additional aspects and/or advantages of the invention will be set forth in part in the description which follows and, in part, will be apparent from the description, or may be learned by practice of the invention.

The foregoing and/or other aspects of the present invention are achieved by providing a cyclonic cleaner including a cyclone unit, wherein the cyclone unit includes a body having an air inlet and an air outlet, a primary cyclone to primarily separate foreign matter from air drawn through the air inlet, a plurality of secondary cyclones to secondarily separate foreign matter from air discharged from the primary cyclone, and to discharge the air having the foreign matter removed therefrom through discharge holes of the secondary cyclones, and a noise reduction member provided to the discharge hole of each secondary cyclone to reduce noise.

The noise reduction member includes a diaphragm partitioning an associated discharge hole of each secondary cyclone, in a direction intersecting inflow air flowing into the secondary cyclone.

The diaphragm is disposed in a perpendicular direction with respect to the air flowing into the secondary cyclone.

The diaphragm bisects a cross-section of the discharge hole of the secondary cyclone.

The discharge hole of the secondary cyclone includes a predetermined height, and the diaphragm is be installed to have a predetermined height from a lower end of the discharge hole.

The cyclone unit further includes a cover plate to cover an upper portion of the primary and secondary cyclones, the cover plate including guidance flow paths through which air is guided into the secondary cyclones.

The discharge holes of the secondary cyclones are formed on the cover plate.

The noise reduction member further includes an air guide to guide the air discharged through the discharge hole of the secondary cyclone towards the air outlet.

The cyclone unit further includes a guide plate to allow the air discharged through the discharge holes of the secondary cyclones to be smoothly discharged through the air outlet.

The guide plate is positioned such that one side of the guide plate faces the air outlet, and the other side of the guide plate faces in a direction opposite to the air outlet.

The guide plate is integrally formed with an upper cover of the body.

It is another aspect of the present invention to provide a cyclonic cleaner including a cyclone unit, wherein the cyclone unit includes a body having an air inlet and an air outlet, a primary cyclone positioned at a center of the body, to primarily separate foreign matter from air drawn through the air inlet, a plurality of secondary cyclones positioned in a circumferential direction around the primary cyclone to secondarily separate foreign matter from air discharged from the primary cyclone, and to discharge the air having the foreign matter removed therefrom through discharge holes of the secondary cyclones, and diaphragms respectively installed in the discharge holes of the secondary cyclones to partition the discharge holes while being disposed in the circumferential direction around the primary cyclone.

It is yet another aspect of the present invention to provide a cyclonic cleaner including a cyclone unit, wherein the cyclone unit includes a body having an air inlet and an air outlet, a primary cyclone to primarily separate foreign matter from air drawn through the air inlet, a plurality of secondary cyclones to secondarily separate foreign matter from air discharged from the primary cyclone and to discharge the air having the foreign matter removed therefrom through discharge holes of the secondary cyclones, and an air guide installed in the discharge hole of each secondary cyclone to guide the air discharged through the discharge hole of the secondary cyclone towards the air outlet.

The cyclone unit further includes a guide plate to allow the air discharged through the discharge holes of the secondary cyclones to be smoothly discharged through the air outlet.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view illustrating a cyclonic cleaner in accordance with an embodiment of the present invention;

FIG. 2 is a longitudinal cross-sectional view illustrating a cyclone unit of the cyclonic cleaner of FIG. 1;

FIG. 3 is a rear view illustrating a cover plate of the cyclone unit of FIG. 2;

FIG. 4 is a graph representing a noise reduction effect by a diaphragm used for the cover plate of FIG. 2; and

FIG. 5 is an exploded perspective view illustrating the cyclone unit of FIG. 2.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

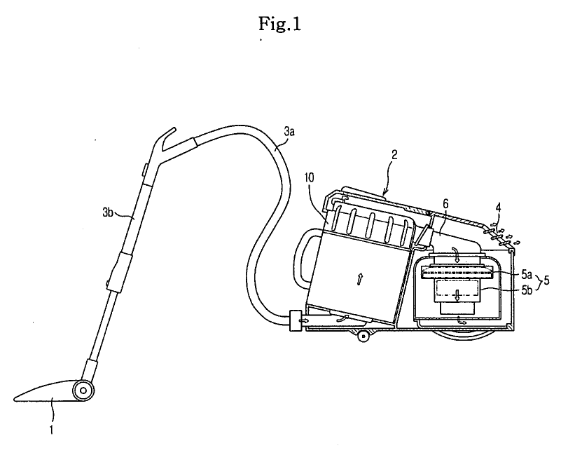

In FIG. 1, a cyclonic cleaner according to an embodiment of the present invention comprises a suction unit 1 to suck foreign matter together with air via suction force, and a body 2 to collect the foreign matter suctioned by the suction unit 1.

The body 2 and the suction unit 1 are connected via a connection hose 3a and a connection pipe 3b such that the suction force generated from the body 2 is transferred to the suction unit 1 therethrough.

The body 2 is connected at a front side with the connection hose 3a to allow air to flow thereto through the connection hose 3a, and comprises an air vent 4 at a rear upper portion thereof, through which, after having the foreign matter removed via a cyclone unit 10 positioned in the body 2, the air is discharged to an outside of the body 2. The body 2 is provided therein with a blower fan unit 5 to generate blowing force and suction force. The blower fan unit 5 comprises a blower fan 5a to generate suction force while rotating, and a motor 5b to rotate the blower fan 5a. The blower fan unit 5 is connected with the cyclone unit 10 by the connection pipe 6.

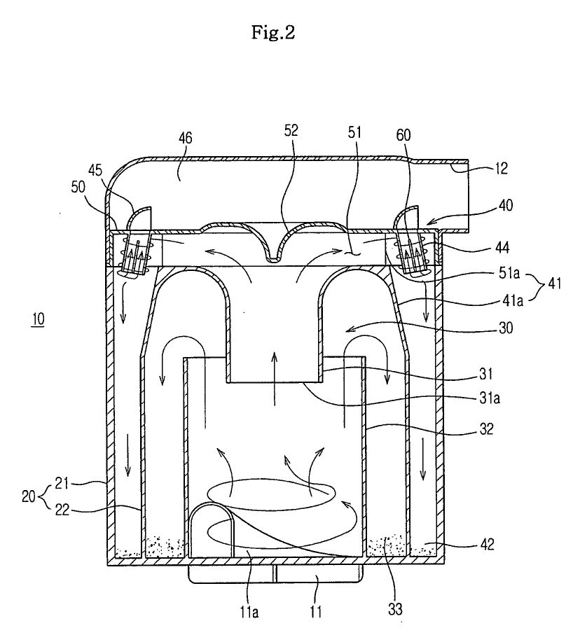

The cyclone unit 10 used for the cyclonic cleaner of FIG. 1 will be described with reference to FIGS. 2 to 5.

As shown in FIG. 2, the cyclone unit 10 according to an embodiment of the present invention comprises a unit body 20 comprising a substantially cylindrical outer container 21 and an inner container 22 positioned within the outer container 21, a primary cyclone 30 positioned within the inner container 22 to primarily separate foreign matter from air sucked into the unit body 20, a plurality of secondary cyclones 40 positioned on the outer container 21 to secondarily separate foreign matter from air discharged from the primary cyclone 30.

The cyclone unit 10 further comprises an air inlet 11 formed at a lower side of the unit body 20, and an air outlet 12 formed at a side upper portion of the unit body 20 such that the air inlet 11 is communicated with the primary cyclone 30, and the air outlet 12 is communicated with the secondary cyclones 40. In addition, after being discharged from the primary cyclone 30, air is divided by guidance flow paths 51 formed on a cover plate 50, and uniformly distributed to the secondary cyclones 40.

The primary cyclone 30 comprises a substantially cylindrical-shaped primary cyclone chamber 31 positioned at an upper center of the inner container 22, and a first dust collection barrel 33 defined by a partition wall 32 within the inner container 22 to collect foreign matter primarily separated by centrifugal force.

The secondary cyclones 40 comprise a plurality of secondary cyclone chambers 41 disposed in a circumferential direction at an upper portion of the outer container 21 and having the same shape and size, and a plurality of second dust collection barrels 42 defined at a lower portion of the outer container 21 to collect foreign matter secondarily separated by the plurality of secondary cyclone chambers 41, respectively. Each of the secondary cyclone chambers 41 is formed by coupling a cone portion 41a formed in the outer container 21 and a cylindrical portion 51a formed in the cover plate 50. Each of the secondary cyclones 40 is positioned at a predetermined angle within the secondary cyclone chambers 41, respectively.

An upper portion of the primary cyclone 30 and the secondary cyclones 40 is covered by the cover plate 50. The cover plate 50 comprises the guidance flow paths 51 to guide the air discharged from the primary cyclone 30 such that the air is uniformly distributed to the plurality of secondary cyclones 40 along the guidance flow paths 51, and with discharge holes 44 through which the air having the foreign matter removed therefrom by the secondary cyclones 40 is discharged.

After being induced through the air inlet 11 formed at a lower side of the unit body 20 and communicated with the primary cyclone 30, air forms circulating air flow in the primary cyclone 30 while passing through a spiral duct 11a. The circulating air flow circulates between an outer peripheral surface of the primary cyclone 30 and the partition wall 32 so that the foreign matter is separated from air by a centrifugal force of the circulating air flow, and collected in the first dust collection barrel 33. Then, the air having the foreign matter removed therefrom by the primary cyclone 30 flows into the primary cyclone chamber 31 through an outlet port 31a formed at a lower portion of the primary cyclone chamber 31, and then moves upward.

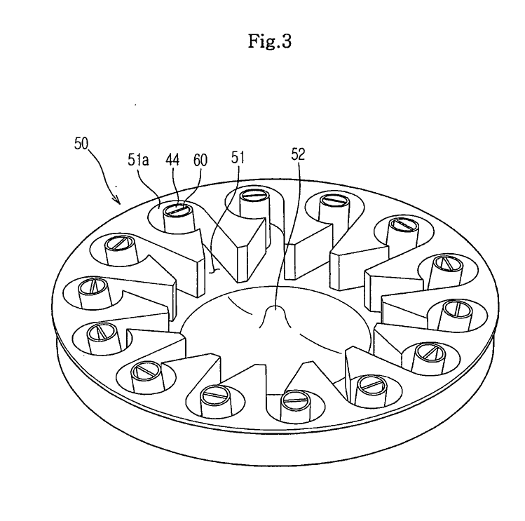

FIG. 3 is a rear view illustrating the cover plate 50 having the guidance flow paths 51 and the discharge holes 44 of the secondary cyclones 40 formed therein.

As shown in FIG. 3, the cover plate 50 comprises a distribution part 52 protruding downwardly from a center thereof, to distribute the air discharged from the primary cyclone chamber 31 in all directions. Here, the guidance flow paths 51 in the cover plate 50, enable the air divided by the partition part 52 to be uniformly distributed to the respective secondary cyclones 40. In the cover plate 50, each guidance flow path 51 is gradually decreased in a cross-sectional area towards an associated secondary cyclone 40, and directs the air towards an inner peripheral surface of the cylindrical portion 51a which constitutes a portion of each secondary cyclone 40. As a result, air is guided to the inner peripheral surface of each cylindrical portion 51a along an associated guidance flow path 51, and rotates along the inner peripheral surface of the cylindrical portion 51a. Thus, some of the air is discharged through the discharge hole 44, while the rest is gradually lowered, and induced into an associated cone portion 41a.

In the cone portion 41a, the air moves downwardly while circulating along an inner peripheral surface of the cone portion 41a so that foreign matter contained in the air falls, and accumulates in the second dust collection barrel 42. Then, the air having the foreign matter secondarily removed therefrom moves upwardly, and is discharged through the discharge holes 44 of the secondary cyclones 40 formed in the cover plate 50.

The discharge hole 44 of each secondary cyclone 40 comprises a diaphragm 60 to reduce circulation of the circulating air flow, which is discharged through the discharge hole 44 in an associated secondary cyclone chamber 41, thereby enabling a reduction of noise generated from each discharge hole 44.

As shown in FIG. 3, the diaphragm 60 is disposed in a direction of intersecting air which flows into the discharge hole 44 through the guidance flow path 51 formed on the cover plate 50. The diaphragm 60 is disposed in a perpendicular direction with respect to the inflow air. Thus, the plurality of diaphragms 60 are disposed in a circumferential direction around the distribution part 52 or the primary cyclone 30 while partitioning the respective discharge holes 44.

The diaphragms 60 are disposed as described above in order to prevent reduction in efficiency of separating the foreign matter by the secondary cyclones 40, which can be caused by other installation positions of the diaphragms 60.

A speed of the circulating air flow induced into each cylindrical portion 51a through an associated guidance flow path 51 is highest at an outer portion of the cylindrical portion 51a, to thereby provide excellent separation efficiency of the foreign matter.

If each diaphragm 60 is disposed in parallel with the air flowing in the discharge hole 44 of each secondary cyclone 40, the circulating air flow is shielded by the diaphragm 60 when the circulating air flow has the highest speed, thereby lowering a separation efficiency of the foreign matter irrespective of enabling reduction of noise.

When the diaphragm 60 is disposed in the discharge hole 44, it bisects a cross-section of the discharge hole 44The diaphragm 60 is disposed in the discharge hole 44, and comprises a predetermined height from a lower end of the discharge hole 44. Therefore, it is possible to avoid circulation of the circulating air flow within the discharge hole 44.

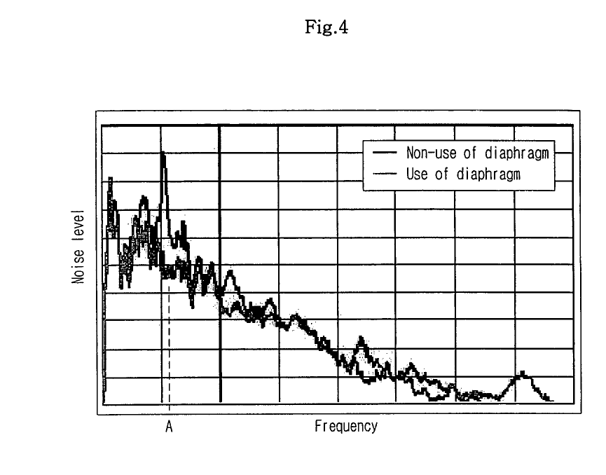

FIG. 4 is a graph representing a noise reduction effect obtained when the diaphragms 60 are disposed in the discharge holes according to the embodiment.

In FIG. 4, A indicates a noise level generated from the discharge holes 44 of the secondary cyclones 40. It can be appreciated that, when the diaphragms 60 described above are disposed in the discharge holes 44, the noise level is remarkably reduced.

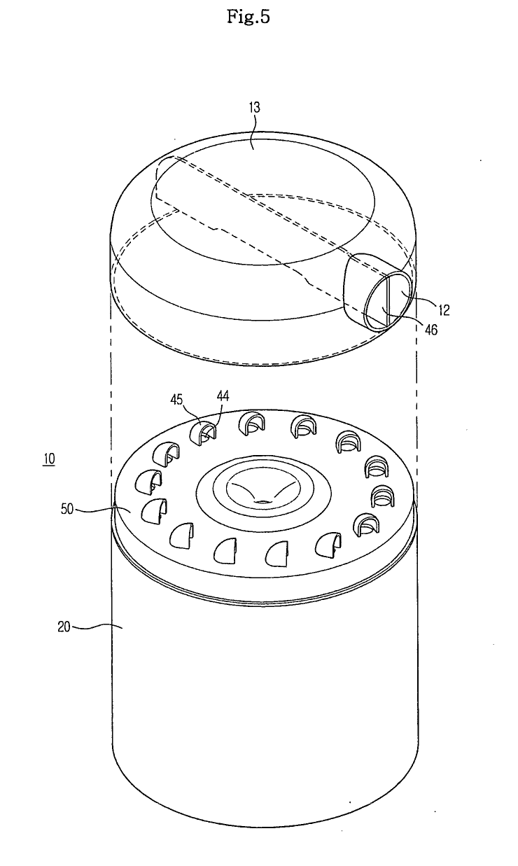

In addition, as shown in FIG. 5, the discharge hole 44 of each secondary cyclone 40 may be provided with an air guide 45 to guide air discharged upwardly through the discharge hole 44 of the secondary cyclone 40 towards the air outlet 12.

Each air guide 45 is formed to face the air outlet 12. The air guides 45 change air flow discharged upwardly through the discharge holes 44 of the secondary cyclones 40 towards the air outlet 12 formed at one side of the unit body 20, thereby preventing noise from being generated due to collision of the air discharged through the discharge holes 44 with an upper cover 13 of the cyclone unit 10. In addition, it is possible to reduce pressure loss, which can occur due to collision with the upper cover 13 while the air is discharged through the air outlet 12 after being discharged through the discharge holes 44.

The plurality of secondary cyclones 40 are disposed in the circumferential direction on the unit body 20. The cyclone unit 10 comprises a guide plate 46 to prevent interference of air discharged through the discharge holes of the plurality of secondary cyclones 40 disposed in the circumferential direction on the unit body while enabling a smooth flow of the air towards the air outlet 12.

The guide plate 46 is positioned such that one side of the guide plate 46 faces the air outlet 12, and the other side thereof faces in an opposite direction thereof. With the guide plate 46 disposed in this manner, it is possible to prevent an interference of air discharged through the discharge holes opposite to each other with respect to the guide plate 46, and to enable smooth flow of the air towards the air outlet 12.

The guide plate 46 is formed on the upper cover 13. The guide plate 46 is integrally formed with the upper cover 13 via injection molding.

As apparent from the above description, the cyclonic cleaner according to the present invention comprises the diaphragms disposed in the discharge holes of the secondary cyclones, enabling reduction of noise generated from the discharge holes.

In addition, each of the discharge holes comprises an air guide, thereby enabling a reduction of noise and pressure loss generated due to collision of air discharged through the discharge holes of the secondary cyclones with the upper cover of the cyclone unit.

In addition, the cyclone unit comprises the guide plate, thereby enabling a smooth flow of the air discharged through the air outlet.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A cyclonic cleaner comprising:
a cyclone unit comprising:
a body having an air inlet and an air outlet,
a primary cyclone to primarily separate foreign matter from air drawn through the air inlet,
a plurality of secondary cyclones to secondarily separate foreign matter from air discharged from the primary cyclone and to discharge the air having the foreign matter removed therefrom through discharge holes of the secondary cyclones, and
a noise reduction member provided to the discharge hole of each secondary cyclone, to reduce noise.

2. The cyclonic cleaner according to claim 1, wherein the noise reduction member comprises a diaphragm partitioning an associated discharge hole in a direction intersecting air flowing into the secondary cyclone.

3. The cyclonic cleaner according to claim 1, wherein the cyclone unit further comprises an inner container and an outer container to house the primary cyclone and the secondary cyclones, respectively.

4. The cyclonic cleaner according to claim 3, wherein the primary cyclone comprises a cylindrical-shaped primary cyclone chamber positioned at an upper center of the inner container; and a first duct collection barrel defined by a partition wall within the inner connector, to collect the foreign matter primarily separated by a centrifugal force.

5. The cyclonic cleaner according to claim 3, wherein the secondary cyclones comprise a plurality of secondary cyclone chambers disposed in a circumferential direction at an upper portion of the outer container, and a plurality of second dust collection barrels defined at a lower portion of the outer container, to collect the foreign matter secondarily separated by the plurality of secondary cyclone chambers, respectively.

6. The cyclonic cleaner according to claim 2, wherein the diaphragm is disposed in a perpendicular direction with respect to the air flowing into the secondary cyclone.

7. The cyclonic cleaner according to claim 2, wherein the diaphragm bisects a cross-section of the discharge hole of the secondary cyclone.

8. The cyclonic cleaner according to claim 2, wherein the discharge hole of the secondary cyclone comprises a predetermined height, and the diaphragm is installed to comprise a predetermined height from a lower end of the discharge hole.

9. The cyclonic cleaner according to claim 5, further comprising:
a cover plate to cover an upper portion of the primary and secondary cyclones, wherein the cover plate comprises guidance flow paths through which air is guided into the secondary cyclones, respectively.

10. The cyclonic cleaner according to claim 9, wherein the discharge holes of the secondary cyclones are formed on the cover plate.

11. The cyclonic cleaner according to claim 9, wherein the outer container further comprises a cone portion, and the cover plate further comprises a cylindrical portion, wherein each secondary cyclone chamber is formed by coupling the cone portion with the cylindrical portion.

12. The cyclonic cleaner according to claim 11, wherein each of the secondary cyclones are positioned at a predetermined angle within the secondary cyclone chambers, respectively.

13. The cyclonic cleaner according to claim 1, wherein the noise reduction member comprises an air guide to guide the air discharged through the discharge hole of each secondary cyclone towards the air outlet.

14. The cyclonic cleaner according to claim 13, further comprising:
a guide plate to allow the air discharged through the discharge holes of the secondary cyclones to be smoothly discharged through the air outlet.

15. The cyclonic cleaner according to claim 14, wherein the guide plate is positioned such that one side of the guide plate faces the air outlet, and the other side of the guide plate faces in a direction opposite to the air outlet.

16. The cyclonic cleaner according to claim 14, wherein the guide plate is integrally formed with an upper cover of the body.

17. A cyclonic cleaner comprising:
a cyclone unit comprising:
a body having an air inlet and an air outlet,
a primary cyclone positioned at a center of the body to primarily separate foreign matter from air drawn through the air inlet,
a plurality of secondary cyclones positioned in a circumferential direction around the primary cyclone to secondarily separate foreign matter from air discharged from the primary cyclone, and to discharge the air having the foreign matter removed therefrom through discharge holes of the secondary cyclones, and
diaphragms respectively installed in the discharge holes of the secondary cyclones, to partition the discharge holes while being disposed in the circumferential direction around the primary cyclone.

18. A cyclonic cleaner comprising:
a cyclone unit comprising:
a body having an air inlet and an air outlet,
a primary cyclone to primarily separate foreign matter from air drawn through the air inlet,
a plurality of secondary cyclones to secondarily separate foreign matter from air discharged from the primary cyclone, and to discharge the air having the foreign matter removed therefrom through discharge holes of the secondary cyclones, and
an air guide installed in the discharge hole of each secondary cyclone to guide the air discharged through the discharge hole of the secondary cyclone towards the air outlet.

19. The cyclonic cleaner according to claim 18, further comprising:
a guide plate to allow the air discharged through the discharge holes of the secondary cyclones to be smoothly discharged through the air outlet.
